(19) United States
(12) Patent Application Publication
(10) Pub. No.: US 2005/0114897 A1
(43) Pub. Date: May 26, 2005

(54) Bookmark service apparatus and method for moving picture content

(75) Inventors: Hyun-Wook Cho, Buk-gu (KR); Dae-Gyue Park, Buk-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/988,619

(22) Filed: Nov. 16, 2004

(30) Foreign Application Priority Data
Nov. 24, 2003 (KR) 2003-83757

(51) Int. Cl. H04N 7/173; H04N 7/16; H04N 5/91; H04N 5/445

(52) U.S. Cl. 725/88; 725/102; 725/112; 725/113; 725/135; 725/47

(57) ABSTRACT

A bookmark service apparatus and method for moving picture content. The bookmark service method bookmarks a playback interval requested by a user who desires to review specific moving image data corresponding to the playback interval when moving image data is reproduced, so that the moving image data initiated from a start point of the bookmarked playback interval can be reproduced. The bookmark service apparatus and method for moving picture content includes registering a specific playback interval as a bookmarked playback interval in a moving image playback mode; and displaying a registered bookmark list by executing a bookmark menu in a standby mode, and reproducing data initiated from a start point of a playback interval of moving picture content selected from among the displayed bookmark list.

This application claims the benefit under 35 U.S.C. 119(a) of an application entitled “BOOKMARK SERVICE METHOD FOR MOVING PICTURE CONTENTS”, filed in the Korean Intellectual Property Office on Nov. 24, 2003 and assigned Serial No. 2003-83757, the entire contents of which are incorporated by reference.

### BACKGROUND OF THE INVENTION

1. Field of the Invention

The present invention relates to a mobile terminal. More particularly, the present invention relates to a bookmark service apparatus and method using image data, which bookmarks a playback interval requested by a user who desires to review specific moving image data corresponding to the playback interval when moving image data is reproduced, so that the moving image data initiated from a start point of the bookmarked playback interval can be reproduced in a moving image playback mode.

2. Description of the Related Art

Following the current trend for quickly developing technologies for mobile communication terminals, a camera function for capturing desired image data using a camera has been recently added to each mobile communication terminal capable of performing a voice communication function.

Recently, mobile communication terminals (also called mobile terminals) have been constructed to include a camcorder function for storing/reproducing moving image data, and a Video On Demand (VOD) function for inquiring about desired image data over a communication network for a user, receiving the desired image data over the communication network, and allowing the user to view the image data in real time, so that the user can view the desired moving image data using his or her mobile terminal.

However, in order to allow the user to review specific moving image data (e.g., best scene) from among overall moving image data in the conventional mobile terminal capable of reproducing such moving image data, the user must directly search for the best scene from the moving image data using a Fast Forward (FF) or Rewind (REW) function, resulting in inconvenience for the user.

Also, in order to search for a correct playback point for the content of a moving picture (i.e., moving image data) that was rapidly reproduced, the user must repeatedly press the FF or REW button several times making it difficult to search for a correct playback interval.

### SUMMARY OF THE INVENTION

Therefore, the present invention has been made in view of the above problems, and it is an object of the present invention to provide a bookmark service apparatus and method for image data, which bookmarks a playback interval requested by a user who desires to review specific moving image data corresponding to the playback interval when moving image data is reproduced, so that the moving image data initiated from a start point of the bookmarked playback interval can be reproduced.

It is another object of the present invention to provide an image data bookmark service apparatus and method which easily and quickly searches for a playback interval requested by a user who desires to review specific moving image data corresponding to the playback interval without using a fast forward (FF) or rewind (REW) function, when moving image data is reproduced, so that the moving image data initiated from a start point of the playback interval can be reproduced.

It is yet another object of the present invention to provide an image data bookmark service apparatus and method for supporting a bookmark service when a user views desired moving image data, so that the user can view moving image data initiated from a start point of a playback interval that is unintentionally suspended while the moving image data is reproduced.

It is yet another object of the present invention to provide an image data bookmark service apparatus and method for easily managing bookmarked moving picture content.

In accordance with one aspect of the present invention, the above and other objects can be accomplished by the provision of a bookmark service apparatus and method for moving picture content. The apparatus and method comprise registering a specific playback interval as a bookmarked playback interval in a moving image playback mode; and displaying a registered bookmark list by executing a bookmark menu in a standby mode, and reproducing data initiated from a start point of a playback interval of moving picture content selected from among the displayed bookmark list.

In accordance with another aspect of the present invention, there is provided a bookmark service an apparatus and method for moving picture content. The apparatus and method comprise registering a specific playback interval as a bookmarked playback interval in a moving image playback mode; displaying a registered bookmark list by executing a bookmark menu in a standby mode, and reproducing data initiated from a start point of a playback interval of moving picture content selected from among the displayed bookmark list; and managing corresponding bookmark moving picture content selected by a menu key from among the displayed bookmark list.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a mobile terminal in accordance with an embodiment of the present invention;

FIG. 2 is a flow chart illustrating a bookmark service method for moving picture content in accordance with an embodiment of the present invention;

FIG. 3 is a view illustrating a bookmark example displayed on the display of FIG. 1 in accordance with an embodiment of the present invention;

FIG. 4 is a flow chart illustrating a bookmark registration method for local moving picture content in accordance with an embodiment of the present invention;

FIG. 5 is a flow chart illustrating a bookmark registration method for network moving picture content in accordance with an embodiment of the present invention; and

FIG. 6 is a view illustrating a method for displaying a registered bookmark list in accordance with an embodiment of the present invention.

### DETAILED DESCRIPTION OF THE PREFERRED EMBODIMENTS

Embodiments of the present invention will now be described in detail with reference to the accompanying drawings. Throughout the drawings, the same or similar elements are denoted by the same reference numerals. In the following description, a detailed description of known functions and configurations incorporated herein will be omitted for conciseness.

It should be noted that a management mode provides a user with a variety of management items displayed in a popup menu window, i.e., a content information item, bookmark addition item, bookmark deletion item, title change item, content change item, and content search item, etc., so that moving picture content corresponding to the selected management item can be managed. The term “local moving picture content” is indicative of moving picture content stored in a memory of a mobile terminal, and the term “network moving picture content” is indicative of real-time moving picture content transferred over the wireless Internet. In this case, it is assumed that the local moving picture content are indicative of moving image content stored over the wireless Internet.

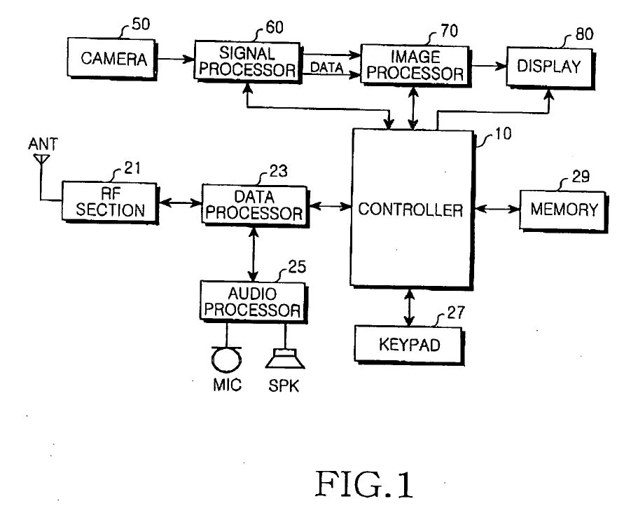

FIG. 1 is a block diagram illustrating a mobile terminal in accordance with an embodiment of the present invention.

Referring to FIG. 1, the radio frequency (RF) unit 21 performs a communication function for the mobile terminal. The RF unit 21 includes a RF transmitter for increasing/amplifying a frequency of a transmission signal; and an RF receiver for low-noise-amplifying a received signal, and reducing a frequency of the received signal.

The data processor 23 includes a transmitter for encoding/modulating the transmission signal; and a receiver for demodulating/decoding the received signal, etc. The data processor 23 may comprise a MODEM or a CODEC. The audio processor 25 reproduces an audio signal generated from the data processor 23, or transmits a transmission audio signal generated from a microphone (MIC) to the data processor 23. The audio processor 25 outputs an audio signal of moving image data reproduced according to an embodiment of the present invention to a speaker (SPK).

The keypad 27 includes a plurality of keys for entering number and character information and a variety of function keys for establishing a variety of functions. The keypad 27 may include menu keys, arrow keys, a bookmark registration key, a confirmation key, and a cancel key, etc.

The memory 29 may comprise a program memory and data memories. The program memory stores programs for controlling general operations of the mobile terminal, a program for bookmarking moving picture content, and a program for registering a bookmark list. The memory stores playback interval information of moving picture content registered in the bookmark list and title information of the moving picture content registered in the bookmark list, Identification Data information of a provider of local moving picture content downloaded over the wireless Internet, and ID information in response to the downloaded local moving picture content. In this case, the memory 29 includes a bookmark list memory area (not shown) for registering/managing the bookmark list.

The controller 10 controls overall operations of the mobile terminal. The controller 10 may include the data processor 23. The controller 10 registers/stores a playback interval of corresponding moving picture content in the bookmark list while the user views the moving image data, reproduces the moving image data initiated from a start point of a playback interval of the moving image content registered in the bookmark list, and manages the moving picture content registered in the bookmark list.

The camera 50 includes a camera sensor for capturing image data, and converting the captured optical signal into an electrical signal. In this case, it is assumed that the camera is indicative of a CCD sensor. The signal processor 60 converts a video signal generated from the camera 50 into an image signal. In this case, the signal processor is implemented with a Digital Signal Processor (DSP).

The image processor 70 generates screen data for displaying the image signal generated from the signal processor 60. The image processor 70 transmits the image signal received by a control signal of the controller 110, image data captured by the camera 50, or image data of moving picture content registered in the bookmark list according to specifications of the display 80. The image processor 70 compresses or expands the image data.

The display 80 displays messages generated when a program is executed upon receiving a control signal from the controller 10. The display 80 displays the image signal generated from the image processor 70 on the screen in a camera capturing mode, and displays user data generated from the controller 10, moving picture content reproduced using an embodiment of the present invention, bookmark list, and bookmark information of moving picture content registered in the bookmark list. In accordance with an embodiment of the present invention, the display 80 displays specific moving picture content initiated from the playback interval of moving picture content registered in the bookmark list. In this case, the display 80 may be implemented using a Liquid Crystal Display (LCD). The display 80 may include an LCD controller, a memory for storing image data, and an LCD display, etc. If the LCD is implemented with a touch-screen LCD, the keypad 27 and the LCD may function as entry units.

Operations of the mobile terminal will hereinafter be described with reference to FIG. 1. If a user performs a dialing operation using the keypad 27 and establishes a call origination mode, the controller 10 detects the established call origination mode, processes dialing information received from the data processor 23, converts the processed dialing information into RF signals using the RF unit 21, and outputs the resultant RF signals. If a counterpart subscriber generates a response signal, the controller 10 detects the response signal over the RF unit 21 and the data processor 23. A voice communication path is formed via the audio processor 25, so that the user can communicate with his or her called party. In the case of a call termination mode, the controller 10 detects the call origination mode using the data processor 23, and generates a ring signal using the audio processor 25. Thereafter, if the user answers the ring signal and generates a response signal, the controller 10 detects the response signal, and forms a voice communication path using the audio processor 25 in such a way that it performs a communication function. Although the call origination mode or the call termination mode uses the voice communication as an example, it should be noted that a data communication function for communication of packet or image data may also be executed along with the voice communication function. If a standby mode or a character communication function is executed, the controller 10 displays character data processed by the data processor 23 on the display 80.

The mobile terminal may capture an image of a person or peripheral environment, and may display or transmit the captured image of the person or the captured image of the peripheral environment on the screen. The camera 50 may be installed in the mobile terminal, or may be connected to a predetermined position of an external device. In other words, the camera 59 may be indicative of an external camera or an internal camera. The camera may use a Charge Coupled Device (CCD) sensor. The image data captured by the camera 50 is converted into an electrical signal using an internal CCD sensor, and the electrical signal is transmitted to the signal processor 60. The signal processor 60 converts the image signal into digital image data, and outputs the digital image data to the image processor 70.

Referring to bookmark service operations of image data using the mobile terminal, the user selects desired moving picture content using the mobile terminal, and views the selected moving picture content.

In this case, the moving picture content mainly includes two types of moving picture content, i.e., local moving picture content downloaded to the mobile terminal over the wireless Internet, and network moving picture content displayed in real time over the wireless Internet.

If the user desires to review a specific scene while viewing the moving picture content, the controller 10 recognizes that the user desires to register the specific scene in the bookmark list using the keypad 27, operates a bookmark-associated program, registers both bookmark information and a playback interval of the moving picture content in the bookmark list, and stores them in the memory 29.

If the user desires to view a playback interval of the moving picture content registered in the bookmark list, the user turns on the bookmark list by pressing the keypad 27, and selects the moving picture content registered in the bookmark list.

The controller 10 recognizes the above situation, reads moving image data corresponding to the moving picture content stored in the memory 29, and displays the read moving image data on the display 80.

If the user selects corresponding moving picture content to manage the moving picture content registered in the bookmark list by pressing the keypad 27, the controller 10 recognizes the above situation, searches for the moving picture content registered in the bookmark list, and executes a management mode during which bookmark information associated with the moving picture content can be corrected, so that it stores the bookmark information of the corrected moving picture content in the memory 29.

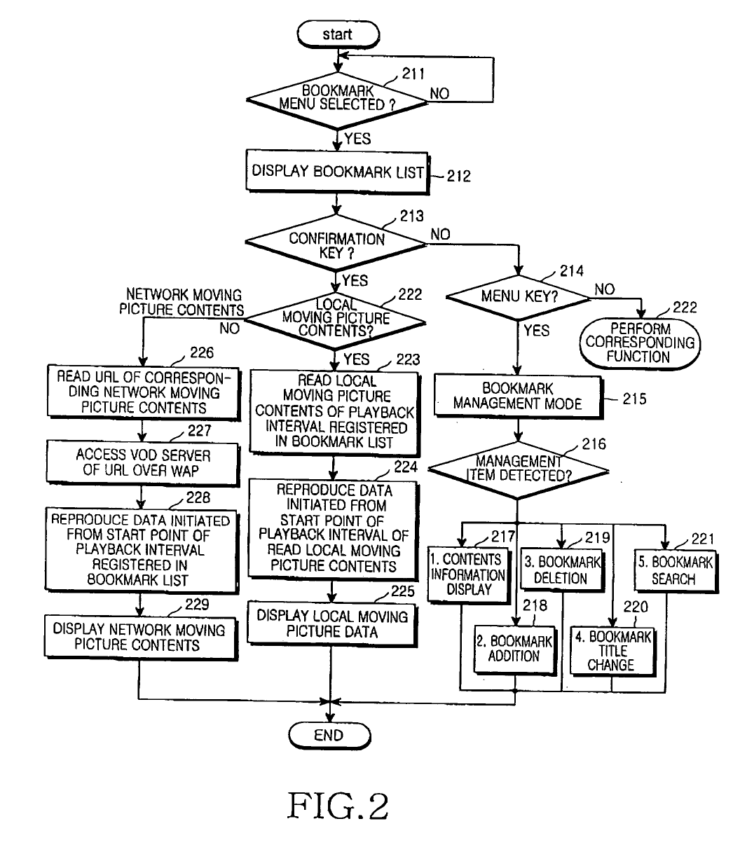

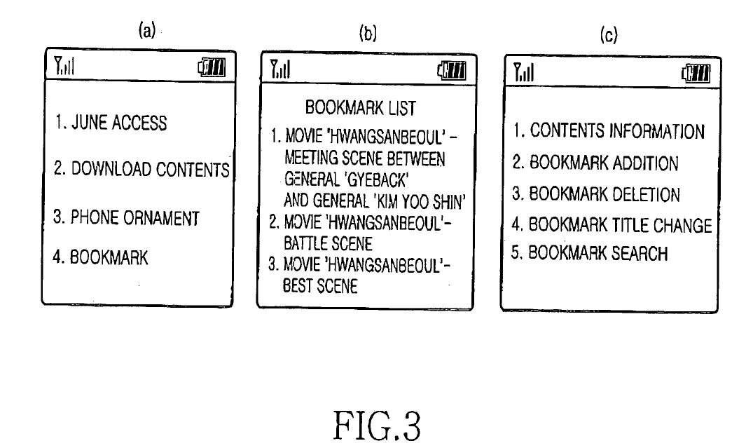

FIG. 2 is a flow chart illustrating a bookmark service method for moving picture content in accordance with an embodiment of the present invention. FIG. 3 is a view illustrating a bookmark example displayed on the display of FIG. 1.

Referring to FIGS. 2 and 3, the controller 10 determines whether a bookmark menu is selected after a menu key is pressed in a standby mode at step 211. If it is determined that the bookmark menu is selected at step 211, the controller 10 displays a screen image of FIG. 3a on the display 80, reads a bookmark list stored in the memory 29, and displays the read bookmark list of FIG. 3b on the display 80.

In this case, in order to display the bookmark list on the display 80, information of a playback interval requested by a user who desires to review moving picture content corresponding to the playback interval while specific moving picture content are displayed and also bookmark information of the specific moving picture content must be stored in the memory 29. A method for bookmarking the playback interval of the specific moving picture content will hereinafter be described.

The moving picture content is classified into local moving picture content stored in the memory 29 over the wireless Internet, and network moving picture content for providing a user with real-time moving picture content after being accessed to a video on demand (VOD) server over the wireless Internet.

A bookmark registration method for the local moving picture content will hereinafter be described with reference to the accompanying drawings.

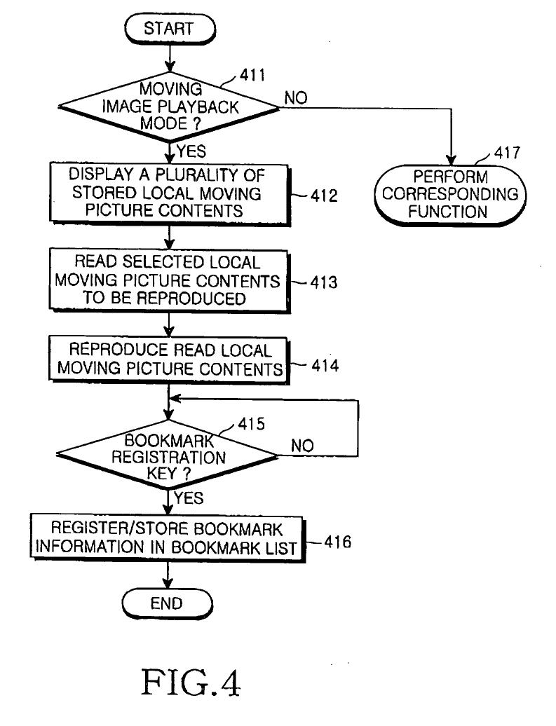

FIG. 4 is a flow chart illustrating the bookmark registration method for local moving picture content in accordance with an embodiment of the present invention.

Referring to FIG. 4, the controller 10 determines whether a user selects a moving image playback mode at step 411. If it is determined that the user selects the moving image playback mode at step 411, the controller 10 performs corresponding functions at step 417. If it is determined that the user selects the moving image playback mode at step 411, a plurality of local moving picture content downloaded/stored in the memory 29 are displayed at step 412.

The controller 10 detects the user-selected local moving picture content from among the plurality of local moving picture content, reads corresponding local moving picture content from the memory 29 at step 413, and reproduces the corresponding local moving picture content using the image processor 70 at step 414.

While the local moving picture content is displayed at step 414, the controller 10 determines whether a bookmark registration key is selected at step 415. If it is determined that the bookmark registration key is not selected, the controller 10 returns to step 415. If it is determined that the bookmark registration key is selected, the controller 10 recognizes the selected bookmark registration key, registers received bookmark information in a bookmark list, and stores the registered bookmark information in the memory 29 at step 416.

In this case, the bookmark information of the local moving picture content is indicative of both a bookmark title needed to register the bookmarked local moving picture content in the bookmark list and a bookmarked playback interval. A specific time at which the bookmark registration key is entered may be stored as time information in the bookmarked playback interval, or a specific playback interval requested by a user who desires to bookmark the specific playback interval may be stored as time information in the bookmarked playback interval.

A bookmark registration method for the network moving picture content will hereinafter be described with reference to the accompanying drawings.

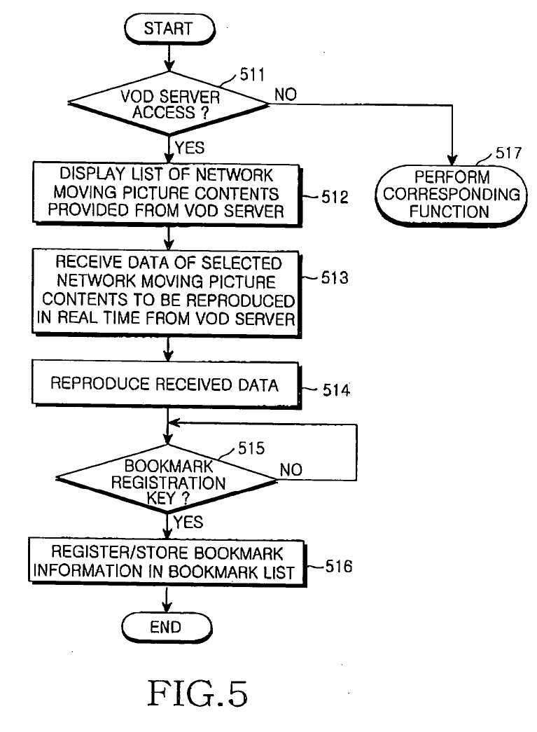

FIG. 5 is a flow chart illustrating the bookmark registration method for network moving picture contents in accordance with a preferred embodiment of the present invention.

Referring to FIG. 5, the controller 10 determines whether it has access to a VOD server over a Wireless Application Protocol (WAP) at step 511. If it is determined that the controller 10 does not have access to the VOD server at step 511, the controller 10 performs corresponding functions at step 517. If it is determined that the controller 10 has access to the VOD server at step 511, the controller 10 displays list information of network moving picture content received from the VOD server at step 512, receives data of selected network moving picture content to be reproduced in real time from the VOD server at step 513, performs streaming of received data, and reproduces the streaming data at step 514.

The controller 10 determines whether the bookmark registration key is entered at step 515 while the network moving picture content is reproduced at step 514. If it is determined that the bookmark registration key is not entered at step 515, the controller 10 returns to step 515. If it is determined that the bookmark registration key is entered at step 515, the controller 10 registers the bookmark registration key in the bookmark list, and stores the registered bookmark registration key in the memory 29.

In this case, the bookmark list of the network moving picture content further includes an ID of a content provider, a content ID, and content Uniform Resource Locator (URL) information in the bookmark information of the local moving picture content.

Returning now to FIG. 2, the controller 10 displays the bookmark list stored in the memory 29 using the steps of FIGS. 4-5 on the display 80 at step 212, and determines whether a confirmation key is entered at step 213. If it is determined that the confirmation key is entered at step 213, the controller 10 determines whether moving image content selected by the confirmation key is equal to local moving picture content or network moving picture content.

The controller 10 determines whether a menu key is entered at step 214 on the condition that the bookmark list is displayed without receiving a signal of the confirmation key. If it is determined that the menu key is not entered at step 214, the controller 10 performs corresponding functions at step 222. If it is determined that the menu key is entered at step 214, the controller 10 enters a bookmark management mode at step 215, so that it can perform appropriate management in response to a management item selected by the management mode at step 216.

The bookmark management mode will hereinafter be described.

As shown in FIG. 3c, the bookmark management mode includes a variety of management items, for example, a content information item, a bookmark addition item, a bookmark deletion item, a bookmark title change item, and a content search item, etc., so that it recognizes the bookmark management item selected by the confirmation key.

If the content information item is selected at step 217, the controller 10 displays a bookmark title and a playback interval time, which are registered when corresponding local moving picture content or network moving picture content stored in the memory 29 are bookmarked. In the case, of the network moving picture content, the controller 10 provides a user with a corresponding URL of the network moving picture content, ID and content ID information of a content provider along with the bookmark title. In this case, the ID and content ID information of the content provider can be used as an ID capable of allowing the user to determine whether user-desired moving picture content is pre-stored in the memory 29 when the user desires to download the specific moving picture content.

If the bookmark addition item is selected at step 218, the controller 10 allows the user to directly bookmark a playback interval of corresponding moving picture content from among the local moving picture content or network moving picture content stored in the memory 29, so that the user can additionally bookmark a desired playback interval.

If the bookmark deletion item is selected at step 219, the controller 10 controls the local moving picture content or network moving picture content stored in the memory 29 to be deleted from the bookmark list, so that the user can freely delete unnecessary bookmark information.

If the bookmark title change item is selected at step 220, the controller 10 can change the title of the local moving picture content or network moving picture content stored in the memory 29 to another title, so that the user can freely change a current title to a desired title and can easily remember the title of the moving picture content. Also, the controller 10 allows the user to enter brief content along with the bookmark title.

If the bookmark search item is selected at step 221, the controller 10 allows the user to search for the local or network moving picture content registered in the bookmark list and stored in the memory 29, so that the user can easily search for desired bookmarked moving picture content from among a plurality of bookmarked moving picture content stored in the bookmark list.

If the confirmation key is selected at step 213, the controller 10 determines whether corresponding moving picture content stored in the bookmark list are equal to local moving picture content or network moving picture content at step 222, and proceeds to step 223 if the local moving picture content is determined. If the local moving picture content is determined, the controller 10 reads corresponding local moving picture content registered in the bookmark list and stored in the memory 29 at step 223, reproduces moving picture content initiated from a start point of a playback interval of the read moving picture content at step 224, and displays moving image data of the local moving picture content on the display at step 225.

Otherwise, if the network moving picture content is determined at step 222, the controller 10 reads URL information of corresponding network moving picture content at step 226, accesses the VOD server over a WAP at step 227, and reproduces moving picture content initiated from a start point of a playback interval registered in the bookmark list at step 228 in such a way that such network moving picture content is displayed on the display 80 at step 229.

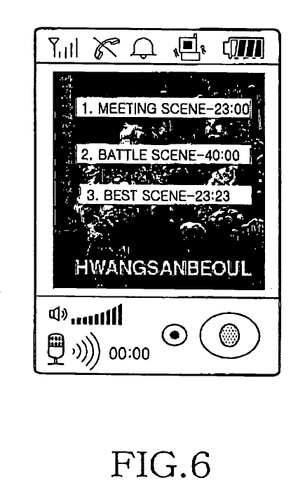

If the user selects a bookmark menu item while the local or network moving picture content is reproduced in order to change a current bookmark list display environment to an example shown in FIG. 6, the bookmark list is overlaid with a natural color capable of allowing the user to easily view the reproduced moving image, the bookmark list overlaid with the natural color is displayed on the reproduced moving picture content, and thereby a currently-reproduced playback interval can be immediately changed to a selected playback interval selected from among the bookmark list.

As apparent from the above description, a bookmark service method for image data according to the present invention bookmarks a playback interval requested by a user who desires to review specific moving image data corresponding to the playback interval when moving image data is reproduced, so that the moving image data initiated from a start point of the bookmarked playback interval can be reproduced, resulting in greater convenience for the user. The present embodiments of the present invention allow the user to bookmark a desired playback interval, so that the user can easily search for a playback interval of desired moving picture content from the registered bookmark list, and can quickly view the searched moving picture content without using a FF or REW function, resulting in a reduction for searching for the desired moving picture content. Also, the embodiments of the present invention can also bookmark a playback interval of real-time moving picture content along with URL information, so that unnecessary charges assessed to the user while the user searches for desired moving picture content using the FF or REW function can be reduced.

Although certain embodiments of the present invention have been disclosed for illustrative purposes, those skilled in the art should appreciate that various modifications, additions and substitutions are possible, without departing from the scope and spirit of the invention as disclosed in the accompanying claims.

1. A bookmark service method for moving picture content, comprising the steps of:
registering a specific playback interval as a bookmarked playback interval in a moving image playback mode; and
displaying a registered bookmark list by executing a bookmark menu in a standby mode, and reproducing data initiated from a start point of a playback interval of moving picture content selected from among the displayed bookmark list.

2. The method according to claim 1, wherein the reproducing step includes the steps of:
determining whether the moving picture content selected from among the registered bookmark list is equal to local moving picture content, and reproducing data initiated from a start point of a bookmarked playback interval if it is determined that the selected moving picture content is equal to the local moving picture contents; and
accessing a Uniform Resource Locator (URL) of the selected network moving picture content over a Wireless Application Protocol (WAP) if the selected moving picture content is equal to network moving picture content but different from the local moving picture content, and reproducing data initiated from a start point of a bookmarked playback interval.

3. The method according to claim 1, wherein the reproducing step further includes the step of:
determining whether a menu key is pressed when the bookmark list is displayed, and managing selected bookmark moving picture content if it is determined that the menu key is pressed.

4. The method according to claim 3, wherein the management step includes the steps of:
determining whether the menu key is pressed, and displaying at least one bookmarked management item on a popup menu window if it is determined that the menu key is pressed; and
recognizing a management item selected from among the displayed management items, and executing a management mode for corresponding moving picture content according to the recognized management item.

5. The method according to claim 1, wherein the management items comprise a moving picture content information item, a bookmark addition item, a bookmark deletion item, a bookmark title change item, and a bookmark search item.

6. The method according to claim 1, wherein the registration step includes the steps of:
determining one of local moving picture content or network moving picture content, and registering/storing time and bookmark title information of a playback interval during which a bookmark registration key is entered in the bookmark list when the local moving picture content is determined; and
storing time and bookmark title information of a playback interval, during which a bookmark registration key is entered, and URL information of corresponding network moving picture content when the network moving picture content is determined.

7. The method according to claim 1, wherein the registration step includes the steps of:
determining one of local moving picture content or network moving picture content, and registering/storing playback time and bookmark title information in the bookmark list when the local moving picture content is determined; and
storing not only playback time and bookmark title information, but also URL information of corresponding network moving picture content when the network moving picture content is determined.

8. A bookmark service method for moving picture content, comprising the steps of:
registering a specific playback interval as a bookmarked playback interval in a moving image playback mode;
displaying a registered bookmark list by executing a bookmark menu in a standby mode, and reproducing data initiated from a start point of a playback interval of moving picture content selected from among the displayed bookmark list; and
managing corresponding bookmark moving picture content selected by a menu key from among the displayed bookmark list.

9. An apparatus for bookmarking moving picture content, comprising:
a memory adapted to store bookmarked moving picture content;
a keypad adapted to enter commands for bookmarking the moving picture content; and
a controller adapted to register a specific playback interval as a bookmarked playback interval in a moving image playback mode, and display a registered bookmark list by executing a bookmark menu in a standby mode, and reproduce data initiated from a start point of a playback interval of moving picture content selected from among the displayed bookmark list.

10. The apparatus according to claim 9, wherein the controller is further adapted to determine whether the moving picture content selected from among the registered bookmark list is equal to local moving picture content, reproduce data initiated from a start point of a bookmarked playback interval if it is determined that the selected moving picture content is equal to the local moving picture content, access a Uniform Resource Locator (URL) of the selected network moving picture content over a Wireless Application Protocol (WAP) if the selected moving picture content is equal to network moving picture content but different from the local moving picture content, and reproduce data initiated from a start point of a bookmarked playback interval.

11. The apparatus according to claim 9, wherein the controller is further adapted to determine whether a menu key is pressed when the bookmark list is displayed, and manage selected bookmarked moving picture content if it is determined that the menu key is pressed.

12. The apparatus according to claim 11, wherein the controller is further adapted to determine whether the menu key is pressed, display at least one bookmarked management item on a popup menu window if it is determined that the menu key is pressed, recognize a management item selected from among the displayed management items, and execute a management mode for corresponding moving picture content according to the recognized management item.

13. The apparatus according to claim 9, wherein the management items comprise a moving picture content information item, a bookmark addition item, a bookmark deletion item, a bookmark title change item, and a bookmark search item.

14. The apparatus according to claim 9, wherein the controller is further adapted to determine one of local moving picture content or network moving picture content, and register/store time and bookmark title information of a playback interval during which a bookmark registration key is entered in the bookmark list when the local moving picture content is determined, and store time and bookmark title information of a playback interval, during which a bookmark registration key is entered, and URL information of corresponding network moving picture content when the network moving picture content is determined.

15. The apparatus according to claim 9, wherein the controller is further adapted to determine one of local moving picture content or network moving picture content, and register/store playback time and bookmark title information in the bookmark list when the local moving picture content is determined, and store playback time and bookmark title information and URL information of corresponding network moving picture content when the network moving picture content is determined.
